(19) United States
(12) Patent Application Publication
(10) Pub. No.: US 2017/0248723 A1
(43) Pub. Date: Aug. 31, 2017

(54) POSITIONING ALONG A STREAMER USING SURFACE REFERENCES

(71) Applicant: CGG SERVICES SAS, Massy Cedex (FR)

(72) Inventor: Laurent DOLLON, Paris (FR)

(21) Appl. No.: 15/513,299

(22) PCT Filed: Sep. 24, 2015
(86) PCT No.: PCT/IB2015/002295

§ 371 Date: Mar. 22, 2017

Related U.S. Application Data
(60) Provisional application No. 62/055,031, filed on Sep. 25, 2014.

(51) Int. Cl. G01V 1/38

(52) U.S. Cl. CPC G01V 1/3835

(57) ABSTRACT

Positioning along a towed streamer is enhanced by using acoustic signals emitted from a surface vehicle that is not physically linked to the survey equipment. The surface vehicle navigates to remain above a target location between the streamer's head and its tail in the towing direction. The positions of acoustic units placed underwater along the streamer or on an adjacent streamer are determined using the acoustic signals emitted by the surface vehicle.

### CROSS REFERENCE TO RELATED APPLICATIONS

This application claims priority and benefit from U.S. Provisional Patent Application No. 62/055,031, filed Sep. 25, 2014, for “Positioning accuracy of streamer using a ROV surface reference,” the entire content of which is incorporated in its entirety herein by reference.

### BACKGROUND

Technical Field

Embodiments of the subject matter disclosed herein generally relate to positioning along towed streamers, such that to obtain sharp images of explored structures from marine seismic data, and more particularly to using a signal emitted by a surface vehicle that has no ties to the survey equipment.

Discussion of the Background

Marine seismic surveys are used to generate images of geophysical structures under the seafloor. The presence or absence of oil and/or gas reservoirs can be assessed based on the images.

As illustrated in FIG. 1, a marine seismic survey system 100 includes a vessel 110 towing one or more seismic sources and streamers at predetermined depths (such as z1) under the water surface 118. Seismic receivers 112 (only a few are illustrated) such as hydrophones are distributed along cables 114 (only one shown), and the resulting equipment is commonly referred to as a “streamer” 116. Seismic wave source 120 generates seismic waves 122a that penetrate the seafloor 124 into the explored structure. Inside the structure, the seismic waves are reflected and refracted by one or more layer interfaces such as 126. Reflected waves 122b emerge from the structure and may be detected by receivers 112.

Seismic receivers 112 acquire seismic data related to the detected waves. For example, the seismic data includes a detection time. Time intervals between when the source generates a seismic wave and when the receivers detect wave-related reflections carry information about the position of interfaces (e.g., R in FIG. 1) inside the geophysical structure under the seafloor.

In order to extract and interpret information in the seismic data, good knowledge of the source's position when the seismic wave was generated and of the receivers' positions when detecting reflections of the seismic wave is required. Note that in this document, the term “position” means three-dimensional coordinates in a universal reference system, while the term “location” refers to a place defined relative to other locations. For example, a receiver is placed at a predetermined location along the streamer, this location being at a certain distance from the streamer's head (and/or the streamer's tail) along the cable. While towed, the streamer's cable may have a shape other than a straight line. Thus, although the receiver's location is known and unchanged, its position is not known and changes in time as the streamer is towed. The term “positioning” means in this context associating a position with a location (e.g., of an acoustic unit or receiver).

A streamer has a length of 6-12 km, and receivers are located at 3-25 m intervals along the streamers. As illustrated in FIG. 2, positions of the streamer's head and its tail are usually monitored, for example, using global positioning systems, GPSs, 255 and 265 tied to the streamer's head (e.g., on vessel 250) and to the streamer's tail (e.g., on tail buoy 260), respectively.

Since radio signals are strongly attenuated in water, receivers along streamer 220 (which is towed below the water surface 290) cannot use radio signals (e.g., communicate with satellites 270 and 280) to determine their positions. Interpolating receivers' positions based on the streamer's head and tail's positions is impractical because water currents and other factors affect the streamer's shape, causing shape alterations and thus large errors in the receivers' positions. Therefore, acoustic units 210 (only some are labeled in FIG. 2) are placed at 3-500 m along the streamer. Acoustic signals 230 and 240 are emitted by acoustic sources tied to the streamer's head and tail (e.g., from vessel 250 and from tail buoy 260). These acoustic signals are retransmitted along the streamer (as suggested by curved dashed lines in FIG. 2) and between streamers (as discussed relative to FIG. 3).

As illustrated in FIG. 3, which is a bird's-eye view of system 200 in FIG. 2, acoustic units 210a-210z's positions are determined using the acoustic signals emitted by the streamer's head and tail and acoustic units on other streamers such as acoustic units 212a-212z on streamer 212. The uncertainty (which is suggested by the circular shapes 310a-310z surrounding the acoustic units) of the determined positions depends on their distances from known reference points from which the acoustic signals are emitted. If uncertainty is small, then the position is determined with high accuracy, while if the uncertainty is large, the position is determined with low accuracy. The closer an acoustic unit is to the streamer's head or its tail, the less the uncertainty of its determined position. Uncertainty is greatest for acoustic units in the middle of the streamer (e.g., 310m and 310n) far from a surface reference position.

The positioning units may be part of other devices attached to the streamer, such as Nautilus steering devices. In Nautilus User's Manual v3.0.39 (which is incorporated herewith by reference in its entirety), distances between devices are calculated to allow determining devices' locations relative to one another.

Receiver positions are then interpolated between neighboring acoustic units' positions. Large uncertainties in the acoustic units' positions allow room for errors in the interpolated receiver positions. These errors cause blurred images to be obtained from the seismic data acquired by the receivers. Deploying additional equipment (such as a float carrying a positioning system and an acoustic source) tied to the streamer is undesirable, because it would extend survey equipment's deployment and/or retrieval time. Moreover, floats' positions are difficult to control and such floats may become entangled with one another or with other equipment, degrading data acquisition efficiency.

Therefore, it would be desirable to provide devices and methods that would enhance positioning along streamers without the above-outlined drawbacks.

### SUMMARY

In order to enhance positioning along a towed streamer, one or more autonomous surface vehicles, ASVs (which are sometimes called remote operated vehicles, ROVs), are deployed between a streamer's head and its tail. Each ASV (whose position is defined through surface positioning means and controlled relative to front and tail end buoys) emits acoustic signals used to determine the positions of acoustic units located on the streamer. Using ASVs that are not tied to the streamer has the advantage that the efficiency of survey equipment operation is not affected by delays or entanglements. Moreover, since ASVs are able to navigate (e.g., to remain above target locations) autonomously, the seismic survey system and its operators are not burdened with additional control tasks.

According to one embodiment, there is a method for positioning along a streamer. The method includes detecting an acoustic signal emitted from a surface vehicle, at a known position between a head of a streamer and a tail of the streamer in a towing direction, the acoustic signal being detected by at least one among acoustic units placed at different locations along the streamer. The method further includes evaluating positions of the acoustic units using the acoustic signal. The surface vehicle is not tied to any piece of survey equipment.

According to another embodiment, there is a surface vehicle usable during seismic surveys for positioning along a streamer. The surface vehicle has a navigation and propulsion system, a positioning system, and an underwater acoustic source. The navigation and propulsion system is configured to maintain the surface vehicle substantially above a target location between a head of the streamer and a tail of the streamer. The positioning system configured to obtain surface vehicle's position. The underwater acoustic source is configured to emit acoustic signals to be detected by acoustic units placed along the towed streamer, thereby enabling evaluation of positions of the acoustic units using the acoustic signals. The surface vehicle is not tied to any piece of survey equipment.

According yet another embodiment, there is an acoustic unit attached to a streamer towed during a marine seismic survey. The acoustic unit has a receiver, a transmitter and a processor. The receiver is configured to receive acoustic signals. The transmitter is configured to retransmit the acoustic signals to adjacent acoustic units. The processor is configured to estimate positions of the acoustic unit using the acoustic signals emitted by a surface vehicle that navigates to be substantially above a target location between a head of the streamer and a tail of the streamer in a towing direction. The surface vehicle is not tied to any piece of survey equipment.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 illustrates a seismic survey system;

FIG. 2 illustrates a conventional positioning technique;

FIG. 3 illustrates positioning accuracy for the seismic survey system in FIG. 2;

FIG. 4 illustrates a positioning technique, according to an embodiment;

FIG. 5 illustrates positioning accuracy for the seismic survey system in FIG. 4;

FIG. 6 is a flowchart of a method for positioning along a streamer according to an embodiment;

FIG. 7 is a survey system according to an embodiment;

FIG. 8 is a schematic diagram of an autonomous surface vehicle according to an embodiment; and

FIG. 9 is a schematic diagram of an acoustic unit, according to an embodiment.

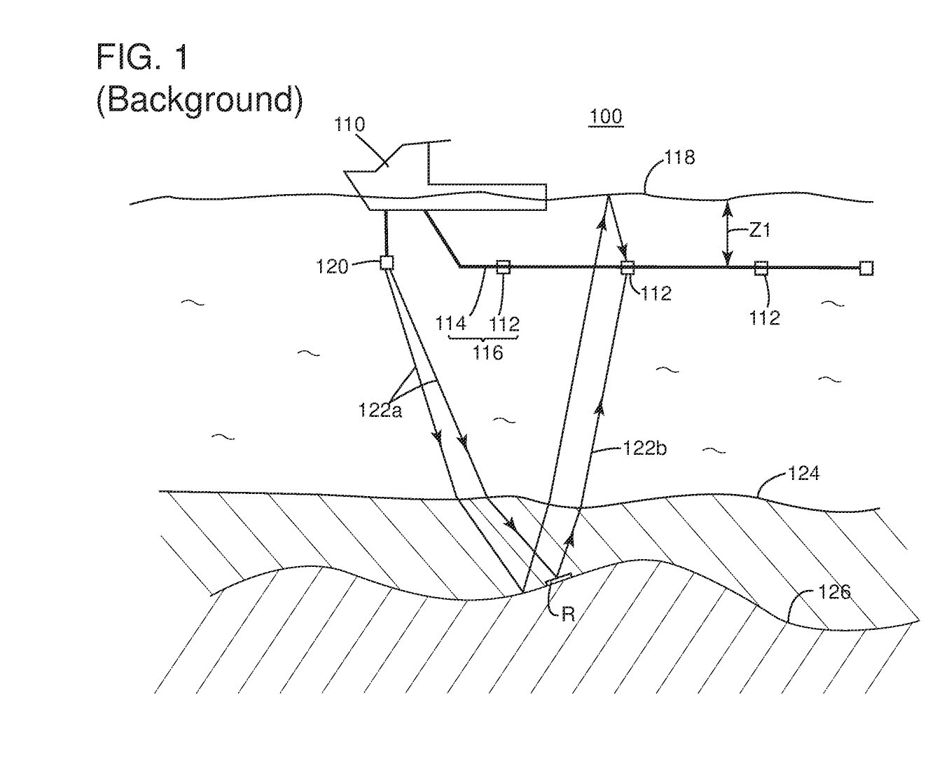

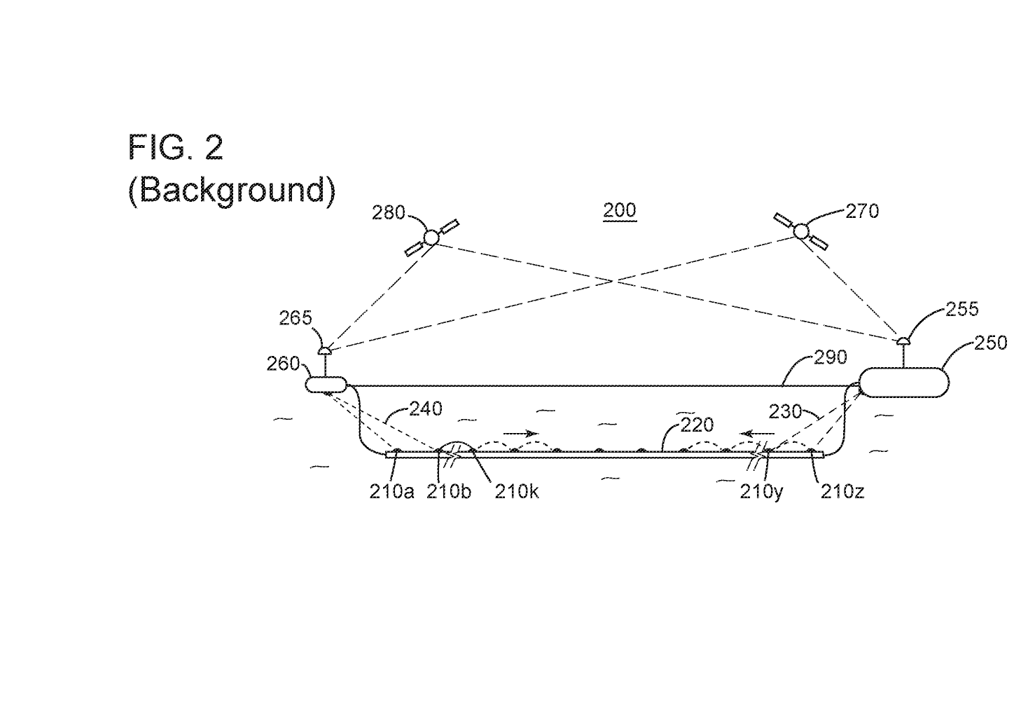

### DETAILED DESCRIPTION

The following description of the exemplary embodiments refers to the accompanying drawings. The same reference numbers in different drawings identify the same or similar elements. The following detailed description does not limit the invention. Instead, the scope of the invention is defined by the appended claims. The following embodiments are discussed with regard to the terminology and structure related to positioning along a streamer during marine seismic surveys.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

In order to enhance positioning accuracy (i.e., decrease uncertainty) along a towed streamer, acoustic signals are emitted from a surface vehicle (which has no physical links to other survey equipment), to be detected by the acoustic units located on the streamer. Because the surface vehicle navigates at the water's surface, its position is readily available (e.g., due to a GPS positioning system onboard the surface vehicle). The surface vehicle's motion may be autonomous (i.e., an autonomous surface vehicle, ASV), remotely controlled or the surface vehicle may even be driven by a person. Although the following description of embodiments mostly refers to ASVs, it should be understood that ASV is an exemplary embodiment of the surface vehicle, not intended to be limiting.

Commercially available ASVs (such as C-Worker and C-Cat 5 described at www.asvglobal.com/oil-gas) are unmanned vehicles able to navigate autonomously on the water surface and to move with the survey speed (e.g., about 5 knots; this value is an example not intended to limit the survey speed).

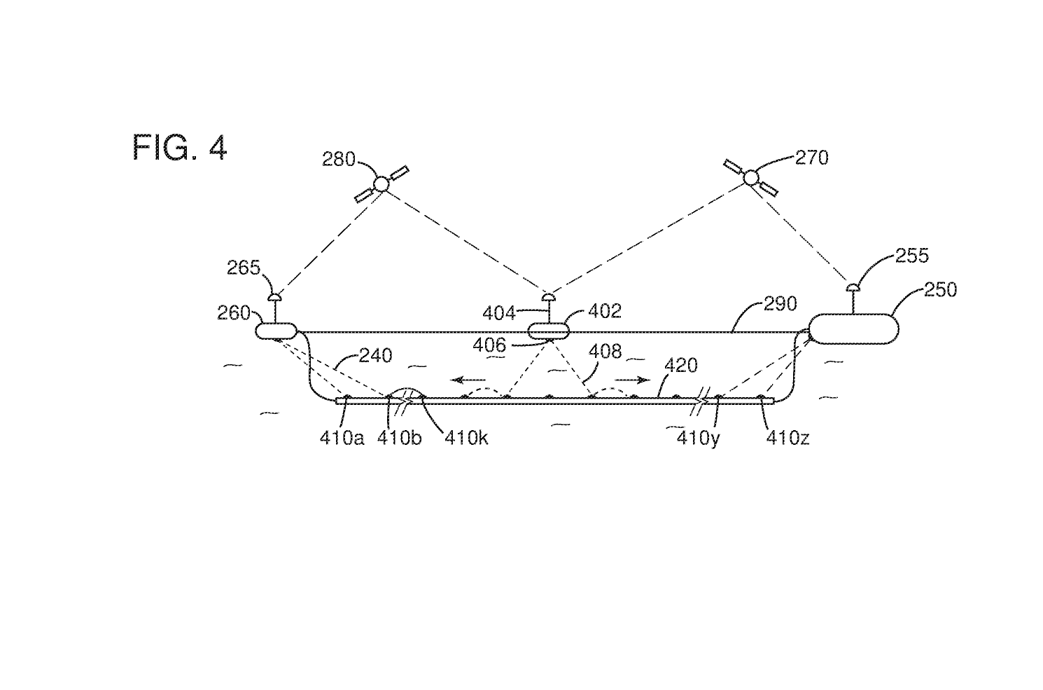

As illustrated in FIG. 4, an ASV 402, according to an embodiment, navigates to be substantially above a target location T, between the head and the tail of streamer 420. Although, the description refers to a target location, it should be understood that the target location may be a function of time; thus, the ASV may move up and down along towing direction. The target location may be the middle of the streamer. Given that the streamer and the ASV move with the survey speed, and that the streamer's length is 6-12 km, the ASV being directly above the target location is an objective, not a de facto characteristic. The ASV may use acoustic signals received from one or more of the acoustic units 410 on the streamer to adjust its motion to be as close as attainable above the target location.

ASV 402 carries a GPS 404 (serving as the positioning system), which receives GPS signals from satellites such as 270 and 280, enabling calculation of the ASV's position. In another embodiment, the ASV may be equipped with other types of positioning systems. For example, ASV may include a radar system used to determine ASV's position relative to radar-visible references at known positions (e.g., the streamer's head and/or tail). Alternatively or automatically, the ASV's position may be determined using aerial radio signals from the ASV and detected by various seismic survey equipment. GPS positioning can be improved either by DGPS (Differential GPS) or RGPS (Relative GPS) use in combination of a reference GPS system installed on one of the vessel involved in the operation. In yet another example, an inertial navigation system (that uses motion sensors and rotation sensors data to continuously calculate the position, orientation, and velocity of a moving object without the need for external references) may be used in addition or instead of the GPS.

ASV 402 also carries source 406 emitting/receiving acoustic signals 408, in water. These acoustic signals are detected/emitted by one or more acoustic units 410a-z attached to streamer 420. Note that labeling the acoustic units in alphabetical order is not intended to convey any information about their number, but merely to suggest a complete series. The propagation time of the signal allows determining the respective distance between acoustic units placed on the streamer and ASV 102. (as suggested by the curved dashed lines and the arrows in FIG. 4).

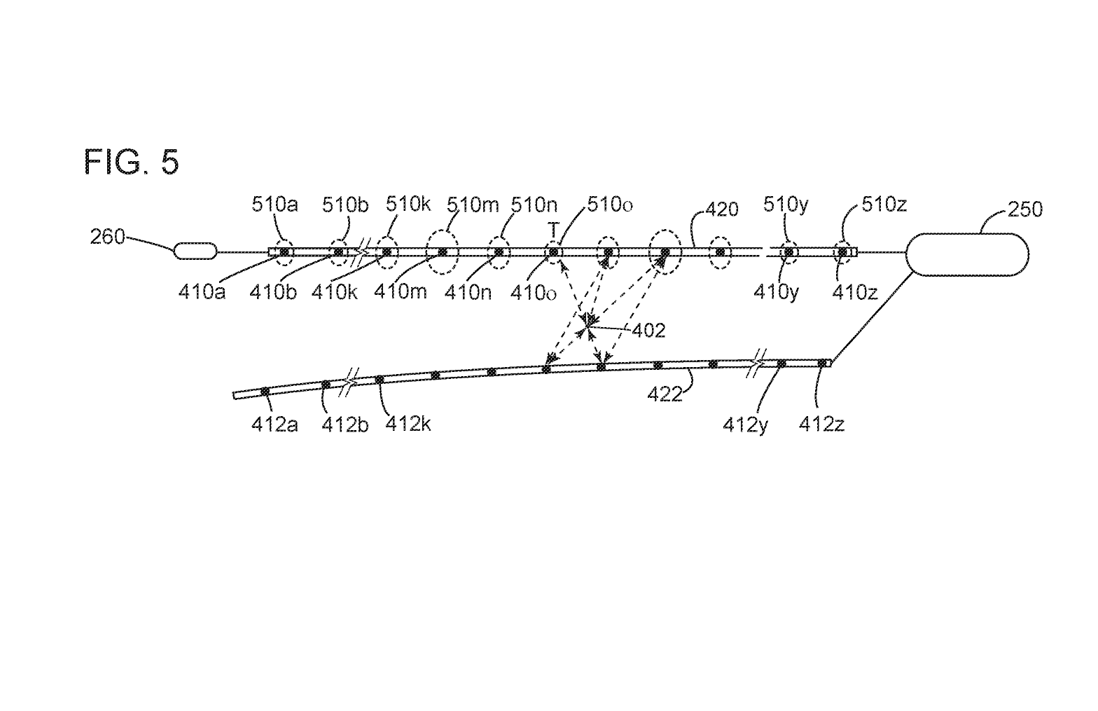

FIG. 5, which is a bird's-eye view of system 400 in FIG. 4, illustrates acoustic unit 410a-410z's positions determined using the acoustic signals from the ASV in addition to the acoustic signals from streamer 420's head and tail or from other streamers (such as streamer 422 carrying acoustic units 412a-z). Position uncertainties (suggested by the circular shapes 510a-510z surrounding the acoustic units 410a-z) depend on the acoustic units' distances from the streamer's head, tail, and from the target location, T, respectively. The closer an acoustic unit is to the streamer's head, tail or target location, the less the uncertainty of its determined position. Uncertainty is greater in middle portions between the streamer's head and the target location, and between the target location and the streamer's tail. In another embodiment, an acoustic unit's position may be determined using other detected acoustic signals emitted another known position, different from the streamer's head or tail.

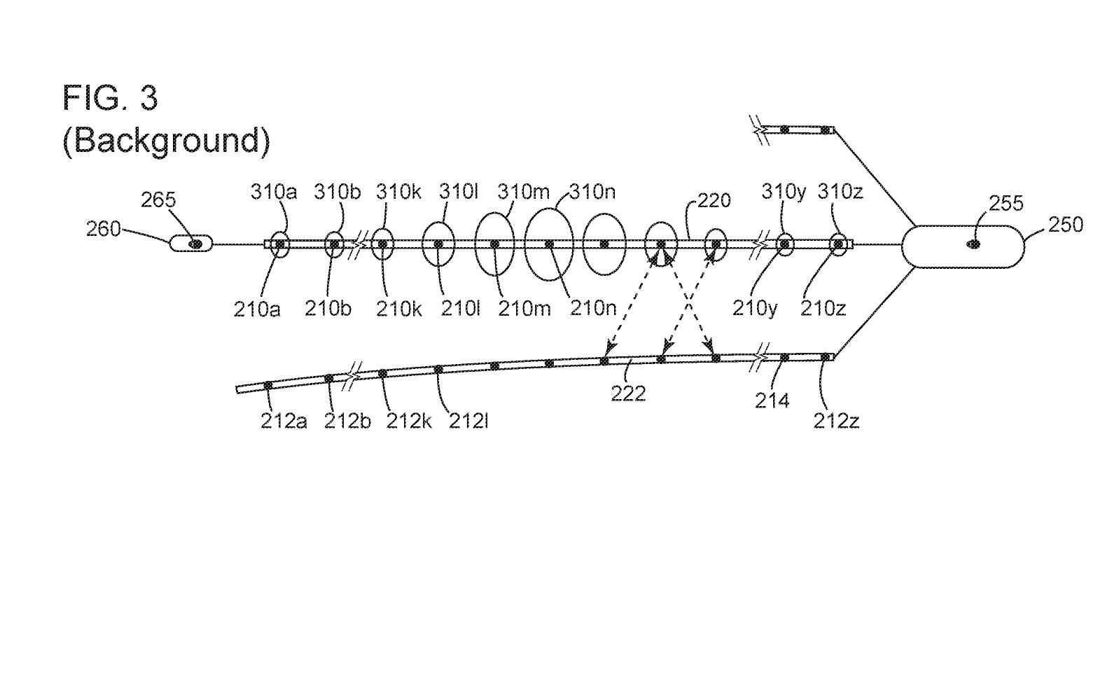

Comparing FIGS. 3 and 5, one observes that the presence of ASV 402 causes decreasing uncertainty for at least a subset of the acoustic units (particularly the ones close to the target location). Decreased uncertainties reduce the room for errors in receiver positions, which translates into sharper images of the subsurface structure obtained from seismic data.

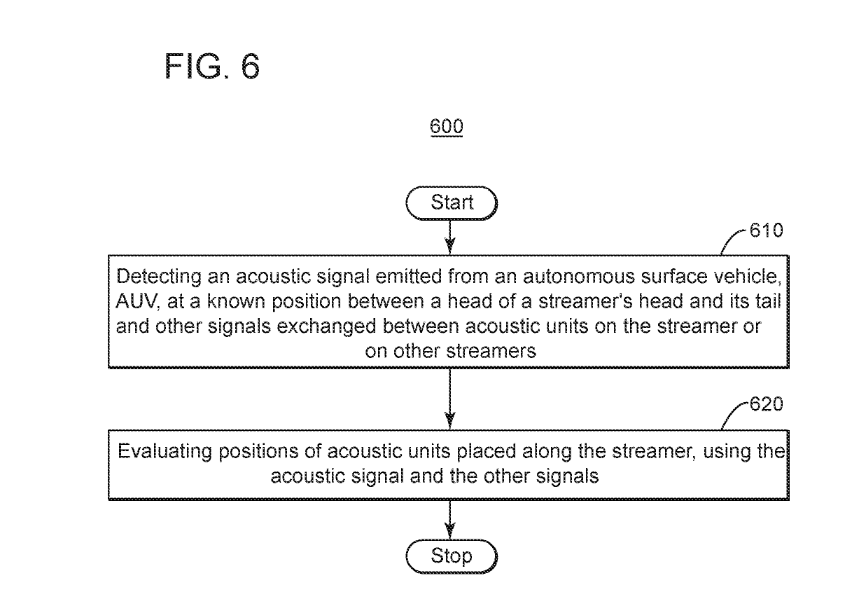

FIG. 6 is a flowchart of a method 600 for determining positions along a streamer during a marine seismic survey. Method 600 includes detecting an acoustic signal emitted from ASV at a known position between a head of a streamer's head and its tail, and other signals exchanged between acoustic units on the streamer or on other streamers, at 610. The acoustic signal from the ASV is detected by at least one among acoustic units placed at different locations along the streamer. It should be understood that more than one such ASV may be provided, different ASVs being associated with different target locations. The target location(s) may be selected to have equal distances there-between and/or to the streamer's head and tail. Alternatively, the target locations may be selected based on seismic data density (the seismic data being acquired by receivers along the streamers). Such a criterion would lead to target locations closer to the streamer's head.

Method 600 further includes evaluating positions of acoustic units placed along the streamer, using the acoustic signal from the ASV and the other signals, at 620. The proposed embodiments improve the accuracy of conventional positioning methods for areas located far from the head and tail of streamers.

The ASV may emit acoustic signals at predetermined time intervals and/or in correlation to the seismic source emitting the seismic waves used for exploring the underground formations. The acoustic units may retransmit the acoustic signals to adjacent acoustic units located along the towed streamer. The acoustic unit does not retransmit acoustic signals received from another acoustic unit, which is farther from the target location than the acoustic unit. The determination of whether a received acoustic signal was received from an acoustic unit which is farther from the target location than the acoustic unit may be based on an identifier of the acoustic unit attached to the received acoustic signal, or on the direction from which the acoustic signal has been received.

An acoustic unit's position may be determined using other detected acoustic signals from another known position. These other acoustic signals may be emitted by positioning units, each including a positioning system and underwater acoustic communication equipment. Such a positioning unit may be placed close at the streamer's head and/or its tail. The positioning unit may be tied to the streamer's head and/or its tail, or may be carried by another ASV.

Preferably, frequencies of the acoustic signals used for positioning are outside a frequency band (e.g., 10-150 Hz) of seismic signals used for the marine seismic survey.

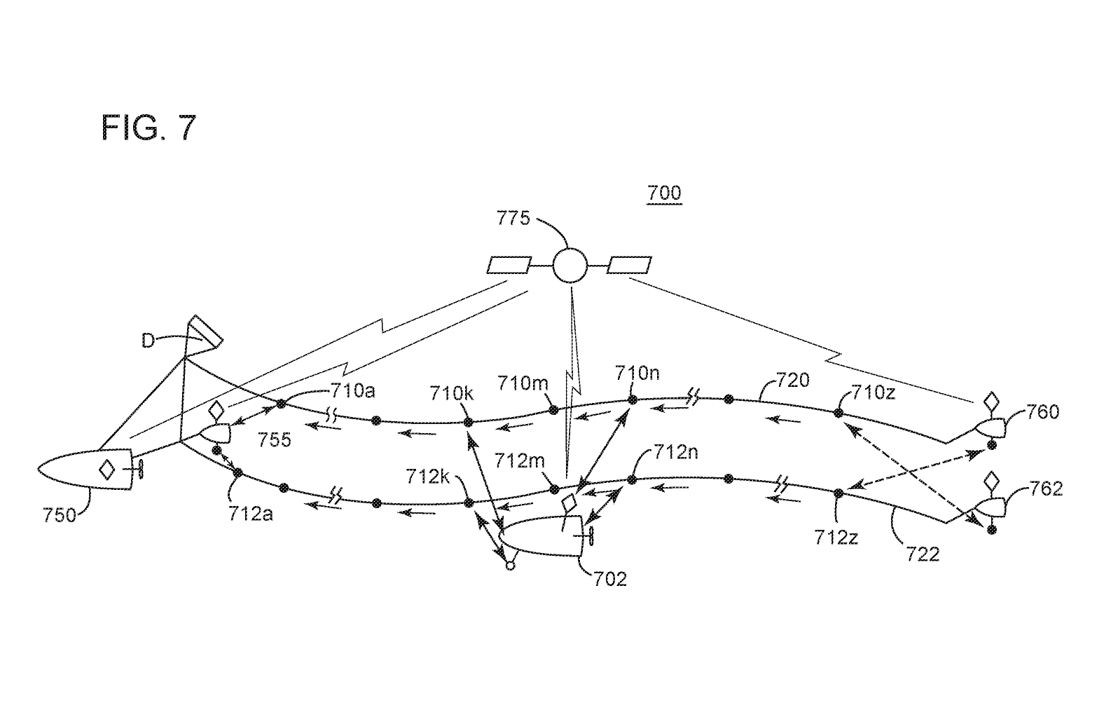

Customarily, a survey vessel tows 4-12 streamers (known as a “spread”) which remain substantially parallel at a 25-200 m interval from one another. However, the parallel-streamers arrangement is exemplary and not intended to be limiting (for example, the streamers may be arranged to be intentionally flared). The interval between parallel streamers is defined in a horizontal plane and perpendicular to the towing direction. FIG. 7 shows two streamers 720 and 722 of a spread and an ASV 702 deployed to enhance positioning accuracy along these streamers. Streamers 720 and 722 are less than 250 m from one another. Deflector D and ropes tied between vessel 750 and the streamers are a support structure ensuring that the streamers are towed substantially at nominal separation. The predetermined interval is maintained between the streamers' heads through remote controlled vertical and lateral steering devices.

In FIG. 7, three positioning units 755, 760 and 762 are tied close to the streamers' heads and to their tails, respectively. These positioning units are in communication with satellites such as 775, thereby being able to calculate their positions.

Positioning units 755, 760 and 762 emit acoustic signals reaching at least one acoustic unit on each streamer. The acoustic signals emitted by positioning unit 755 are detected by both acoustic unit 710a on streamer 720 and acoustic unit 712a on streamer 722. These signals are then retransmitted from one acoustic unit to neighboring acoustic units toward the tails of streamers 720 and 722, i.e., acoustic units 710z and 712z, respectively. The location of the positioning units may be determined by triangulation using signals received from neighboring positioning units along the same streamer and on an adjacent streamer.

Positioning unit 760 and 762 emit acoustic signals detected by acoustic unit 710z on streamer 720 and acoustic unit 712z on streamer 722. These acoustic signals are then retransmitted from one acoustic unit to the next toward the streamers' heads, i.e., units 710a and 712a, respectively.

ASV 702 carries a GPS in communication with satellites (such as 775), thereby being able to calculate its positions. ASV 702 navigates to be substantially above a target location, e.g., acoustic unit 712n. ASV 702 emits acoustic signals detected by acoustic units on both streamer 720 and streamer 722 (as suggested by the double arrows). The acoustic units 710a-z and 712a-z's positions are determined using acoustic signals received from ASV 702, and from positioning unit 755, from positioning unit 760 or from positioning unit 762. The additional reference signal emitted by the ASV may be particularly useful when data is acquired which the streamers are towed in non-linear sailing patterns (e.g., coils, ovals, ellipses or when shooting through turns).

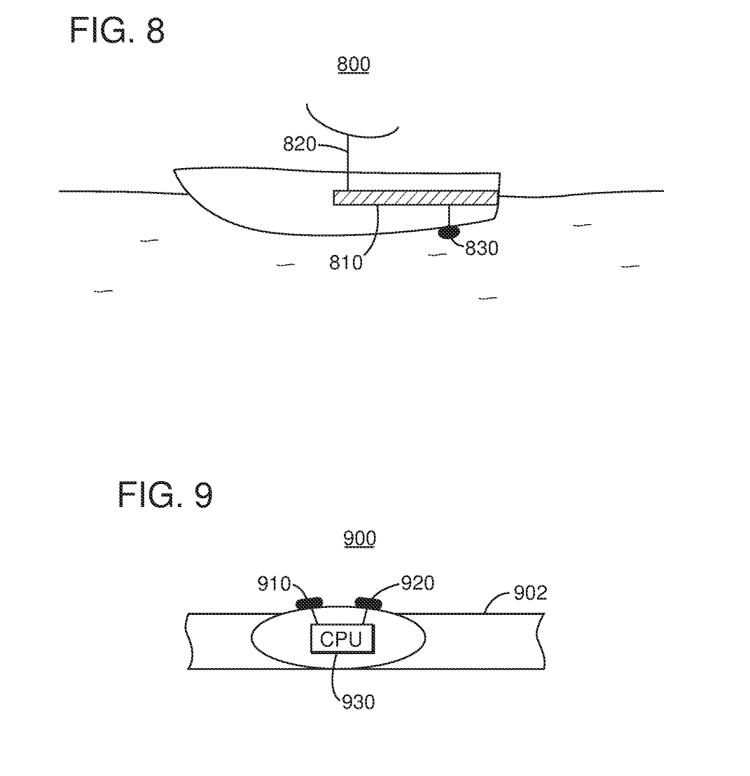

FIG. 8 illustrates an ASV 800 according to an embodiment. ASV 800 may be used at ASV 402 in FIG. 4 during a seismic survey. ASV 800 has a navigation and propulsion system 810, a positioning system 820, and a underwater acoustic source 830. The navigation and propulsion system 810 is configured to maintain the ASV substantially above a target location (e.g., T in FIG. 4) between a streamer's head and tail. There is no physical tie (cable or rope) linking the ASV to the streamer, and system 810 operates automatically (without human supervision). Navigation and propulsion systems may be configured to remain substantially above the target location using secondary acoustic signals received from the acoustic units.

GPS 820 is configured to determine the ASV's position based on satellite signals. However, the AVS may carry other types of positioning units such as a positioning unit using radar type of devices to find out its position relative to the streamer's head and tail, which have known positions and are within the radar range.

Underwater acoustic source 830 is configured to emit acoustic signals in water, toward acoustic units placed along the streamer, thereby enabling evaluation of positions of the acoustic units using ASV-emitted acoustic signals.

ASV 800 may further include a communication unit configured to send GPS positions of the ASV when the underwater acoustic source emits acoustic signals. In one embodiment the ASV may transmit its current position via the acoustic signal. In another embodiment the ASV may transmit its current position via radio signals. The position of the ASV does not have to be synchronized with the acoustic signal. An extrapolation of the ASV's position between two GPS reference points may be enough to improve the spread positioning.

FIG. 9 is a schematic diagram of an acoustic unit 900 attached to a streamer 902 towed during a marine seismic survey, according to another embodiment. Acoustic unit 900 may be one of the acoustic units 410 in FIG. 4. Acoustic unit 900 includes a receiver 910, a transmitter 930, and a processor 930. Receiver 910 is configured to receive a first acoustic signal emitted from the streamer's head, a second acoustic signal emitted from the streamer's tail, and/or a third acoustic signal emitted by an ASV that navigates to be substantially above a target location between the streamer's head and its tail.

Transmitter 920 is configured to retransmit at least one of the first, the second and the third acoustic signals to neighboring acoustic units. Processor 930 is configured to estimate positions of the acoustic unit using the third acoustic signal. Processor 930 may be configured to evaluate a current position of the acoustic unit based on each one, each combination of two, and all the first, second and third acoustic signals, and to output, as the current position, an evaluation result having the least uncertainty.

Acoustic unit 900 may further include a communication module configured to transmit the positions and/or data related to the first, the second and the third signals to a data acquisition system. Acoustic unit 900 may also include a depth sensor configured to provide a current depth of the acoustic unit to the processor.

The disclosed exemplary embodiments provide methods and devices that enhance positioning along a towed streamer. It should be understood that this description is not intended to limit the invention. On the contrary, the exemplary embodiments are intended to cover alternatives, modifications and equivalents, which are included in the spirit and scope of the invention as defined by the appended claims. Further, in the detailed description of the exemplary embodiments, numerous specific details are set forth in order to provide a comprehensive understanding of the claimed invention. However, one skilled in the art would understand that various embodiments may be practiced without such specific details.

Although the features and elements of the present exemplary embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

1. A method for positioning along a streamer, the method comprising:
detecting an acoustic signal emitted from a surface vehicle, at a known position between a head of a streamer and a tail of the streamer in a towing direction, the acoustic signal being detected by at least one among acoustic units placed at different locations along the streamer; and
evaluating positions of the acoustic units using the acoustic signal,
wherein the surface vehicle is not tied to any piece of survey equipment.

2. The method of claim 1, further comprising:
detecting, by one or more of the acoustic units, another acoustic signal emitted from another known position; and
evaluating the positions of the acoustic units using also the other acoustic signal.

3. The method of claim 2, wherein the other known position is the head of the streamer or the tail of the streamer, head and tail positions being known.

4. The method of claim 1, wherein the surface vehicle is maintained substantially above a target location (T) on the streamer.

5. The method of claim 4, wherein, secondary acoustic signals received from at least one of the acoustic units are used to maintain the surface vehicle above the target location.

6. The method of claim 1, further comprising:
evaluating positions of other acoustic units placed at predetermined locations along another streamer adjacent to the towed streamer, at less than 250 m perpendicular the streamer in the towing direction.

7. The method of claim 6, wherein the positions of the other acoustic units are evaluated using also at least one other acoustic signal emitted from another known position.

8. The method of claim 1, wherein one or more frequencies of the acoustic signal are outside a frequency band of seismic signals used for the marine seismic survey.

9. The method of claim 1, further comprising:
sending data related to the detected acoustic signal from the acoustic units to a navigation data acquisition system.

10. The method of claim 1, wherein the positions are evaluated by the acoustic units using the known position and the method further comprises:
sending the positions from the acoustic units to a data acquisition system.

11. The method of claim 1, wherein the positions of acoustic units include estimated errors, respectively.

12. The method of claim 1, further including:
using the positions of the acoustic units to interpolate positions of receivers located along the streamer between the acoustic units.

13. The method of claim 1, further comprising:
calculating a shape of the streamer using the positions of the acoustic units.

14. A surface vehicle, ASV, usable during seismic surveys for positioning along a streamer, the surface vehicle comprising:
a navigation and propulsion system configured to maintain the surface vehicle substantially above a target location between a head of the streamer and a tail of the streamer;
a positioning system configured to determine surface vehicle's position; and
an underwater acoustic source configured to emit acoustic signals to be detected by acoustic units placed along the towed streamer in a towing direction, thereby enabling evaluation of positions of the acoustic units using the acoustic signals,
wherein the surface vehicle is not tied to any piece of survey equipment.

15. The surface vehicle of claim 14, wherein the navigation and propulsion system operates automatically and remains substantially above the target location using secondary acoustic signals received from the acoustic units.

16. The surface vehicle of claim 14, wherein the positioning system is configured to record surface vehicle's positions when the underwater acoustic source emits the acoustic signals.

17. An acoustic unit attached to a streamer towed during a marine seismic survey, the acoustic unit comprising:
a receiver configured to receive acoustic signals;
a transmitter configured to retransmit the acoustic signals to adjacent acoustic units; and
a processor configured to estimate positions of the acoustic unit using the acoustic signals emitted by a surface vehicle that navigates to be substantially above a target location between a head of the streamer and a tail of the streamer in a towing direction, and is not tied to any piece of survey equipment.

18. The acoustic unit of claim 17, further comprising:
a position data communication module configured to transmit the positions and/or data related to the acoustic signals together with a time stamp.

19. The acoustic unit of claim 17, wherein the processor estimates a current position of the acoustic unit based on the acoustic signals and another acoustic signal emitted from another known position.

20. The acoustic unit of claim 17, further comprising:
a depth sensor connected to the processor and configured to measure a current depth of the acoustic unit.
